(19) United States
(12) Patent Application Publication
(10) Pub. No.: US 2025/0322296 A1
(43) Pub. Date: Oct. 16, 2025

(54) DATA-FREE KNOWLEDGE DISTILLATION FOR TEXT CLASSIFICATION

(71) Applicant: INTERNATIONAL BUSINESS MACHINES CORPORATION, ARMONK, NY (US)

(72) Inventors: PRASHANTH VIJAYARAGHAVAN, FREMONT, CA (US); EHSAN DEGAN, RANCHO SANTA MARGARITA, CA (US); LUYAO SHI, NEW HAVEN, CT (US); TYLER BALDWIN, ANN ARBOR, MI (US); DAVID JAMES BEYMER, SAN JOSE, CA (US)

(21) Appl. No.: 18/635,109

(22) Filed: Apr. 15, 2024

(51) Int. Cl. G06N 20/00

(52) U.S. Cl. CPC G06N 20/00

(57) ABSTRACT

Data-free knowledge distillation for text classification can include generating, by a knowledge transfer system, a knowledge transfer dataset comprising a set of synthesized data samples adapted for a text classification task. A large language model is guided by a teacher model in generating the set of synthesized data samples. The knowledge distillation also includes training, by the knowledge transfer system using the teacher model, a student model by using the knowledge transfer dataset.

### BACKGROUND

The present disclosure relates to methods, computer systems, and computer program products for data-free knowledge distillation for text classification. Language models built on artificial neural networks are commonly used for natural language processing tasks such as text classification. Text classification includes fitting a sequence of unstructured text to one or more predefined classifications. Knowledge distillation is a process in which a smaller model, often referred to as the ‘student’ model, is trained to mimic the behavior of a larger, more complex model known as the ‘teacher’ model. The goal is to transfer the knowledge encoded in the teacher model to the student model, allowing the student to achieve similar performance while being computationally more efficient.

### SUMMARY

According to embodiments of the present disclosure, various computer-implemented methods, computer systems and computer program products for data-free knowledge distillation for text classification are described herein. In some aspects, data-free knowledge distillation for text classification includes a knowledge transfer system that transfers the text classification knowledge of a teacher machine learning model to a student machine learning model while meeting data-free constraints. In some aspects, the knowledge transfer system generates a knowledge transfer dataset that includes a set of synthesized data samples adapted for a text classification task. The synthesized data samples are generated using a language machine learning model that is guided by a teacher machine learning model. The knowledge transfer system uses the teacher model and the knowledge transfer dataset to train the student model.

### BRIEF DESCRIPTION OF THE DRAWINGS

FIG. 1 sets forth an example computing environment according to aspects of the present disclosure.

FIG. 2A sets forth an example framework for data-free knowledge distillation for text classification according to aspects of the present disclosure.

FIG. 2B sets forth another depiction of the example framework for data-free knowledge distillation for text classification according to aspects of the present disclosure.

FIG. 2C sets forth another depiction of the example framework for data-free knowledge distillation for text classification according to aspects of the present disclosure.

FIG. 3 sets forth an example method of data-free knowledge distillation for text classification according to aspects of the present disclosure.

FIG. 4 sets forth another example method of data-free knowledge distillation for text classification according to aspects of the present disclosure.

FIG. 5 sets forth another example method of data-free knowledge distillation for text classification according to aspects of the present disclosure.

FIG. 6 sets forth another example method of data-free knowledge distillation for text classification according to aspects of the present disclosure.

### DETAILED DESCRIPTION

In the field of machine learning, Knowledge distillation (KD) has emerged as a popular model compression technique to efficiently transfer knowledge from a large pre-trained model (referred to as a ‘teacher’ model) to a much smaller model (referred to as a ‘student’ model). Many of these distillation methods remain dependent on the original training data to train the student model. However, there are several practical scenarios where such data is not always accessible or available (referred to herein as “data-free” settings). Data-free approaches for knowledge distillation may be used to overcome challenges with data accessibility arising from confidentiality, privacy, and security policies. Thus, efficient knowledge distillation under data-free settings is an open challenge. Further, the limited efforts to tackle data-free knowledge distillation focus primarily on homogeneous model, i.e., where the student and teacher models belong to the same base model with the former being a compressed version of the latter.

There have been various approaches to addressing the challenge of a lack of access to original training data for knowledge distillation in the field of computer vision. However, many of these approaches rely on the prior data distribution captured in the teacher's batch normalization (BN) layers to reconstruct or synthesize images. The synthesized images are used as the transfer set for training the student model using the conventional knowledge distillation algorithms. Such methods are not easily transferable to the language domain due to the discrete nature of texts and the lack of a standardized batch normalization layers in popular language models.

While there are approaches directed to tackling the challenge of data-free knowledge distillation in the field of natural language processing, the major drawbacks include: (a) the use of unintelligible text as pseudo-data samples to train the student model, and (b) the limited applicability of key methods under heterogenous settings as the methods primarily are modeled and evaluated for homogeneous architectures. One embedded guessing-based approach that is used to craft pseudo samples for training the student mode focuses on the category of the text to produce synthetic utterances for training the student model. However, these synthetic utterances are generally unnatural, lacking proper semantic and syntactic structure due to the pseudo-embeddings produced by making updates in the continuous representational space instead of sampling discrete text. Another approach addresses this challenge using a prompt-based reinforcement learning approach to control data synthesis. However, the prompt-based reinforcement learning approach requires the pre-trained teacher model to be queried multiple times for optimization causing an increase in inference costs. Moreover, designing proper task or domain-dependent reward functions is critical to mitigate the instabilities in the reinforcement learning training.

Embodiments in accordance with the present disclosure provide a knowledge transfer system to train both homogeneous and heterogenous student models efficiently under data-free settings. Data-free knowledge distillation includes two steps: (a) generating a set of synthetic data samples tailored for a text classification task using a Large Language Model (LLM) guided by a teacher model (these synthetic data samples serve as the knowledge transfer dataset, also known as the transfer set); and (b) training a student model using the synthesized knowledge transfer dataset by comparing its output distribution to that of the teacher model. In some aspects, pseudo-data samples are generated with the guidance of the pre-trained teacher model to produce class-conditional synthetic text samples that are included in a knowledge transfer dataset. In some aspects, additional samples are generated by diversifying the pseudo-data to provide regularization and generalization to the knowledge transfer dataset. In some aspects, a progressive distillation strategy is used to train the student model. This iterative training strategy may employ a loss function that utilizes the output logits from the pre-trained teacher model and prior student model predictions for optimizing the student model in the current training epoch.

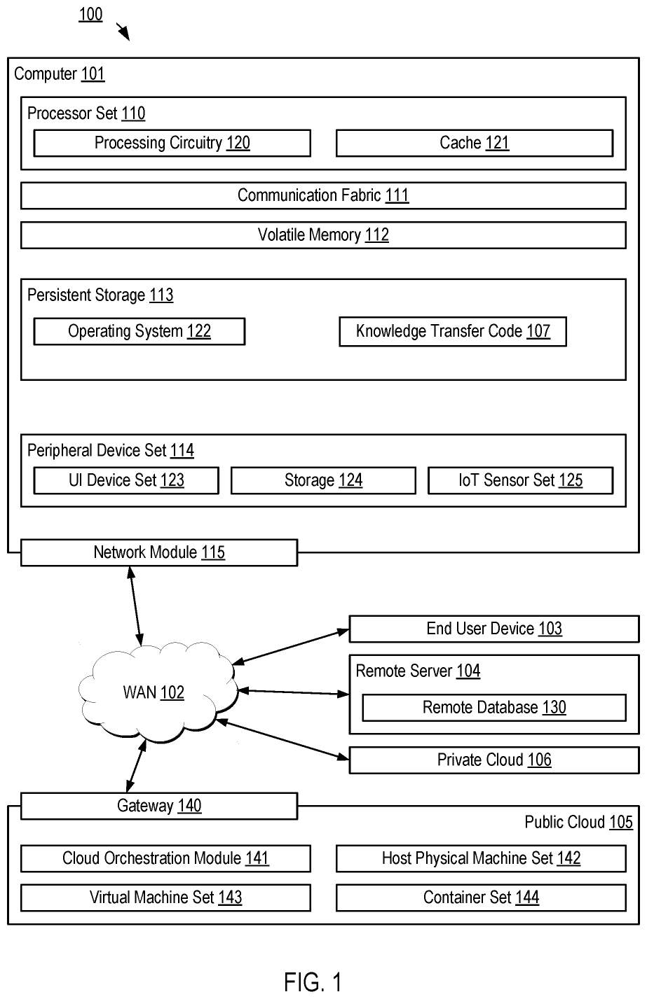

For further explanation, FIG. 1 sets forth an example computing environment according to aspects of the present disclosure. Computing environment 100 contains an example of an environment for the execution of at least some of the computer code involved in performing the various methods described herein, such as knowledge transfer code 107. In some examples, the knowledge transfer code 107 includes computer programming instructions that, when executed by computer, cause the computer to implement one or more of modules of a knowledge transfer system including a steerable generation module, a progressive distillation module, pre-trained teacher model, a student model, and/or a generative language model that are described in more detail below.

In addition to knowledge transfer code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and knowledge transfer code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in knowledge transfer code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in knowledge transfer code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

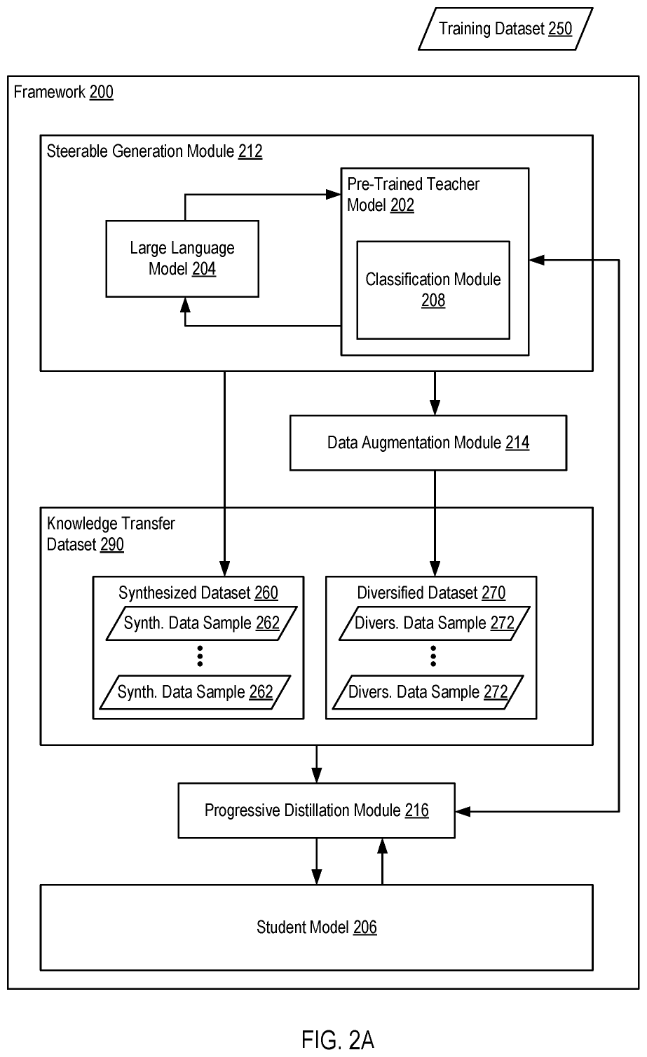

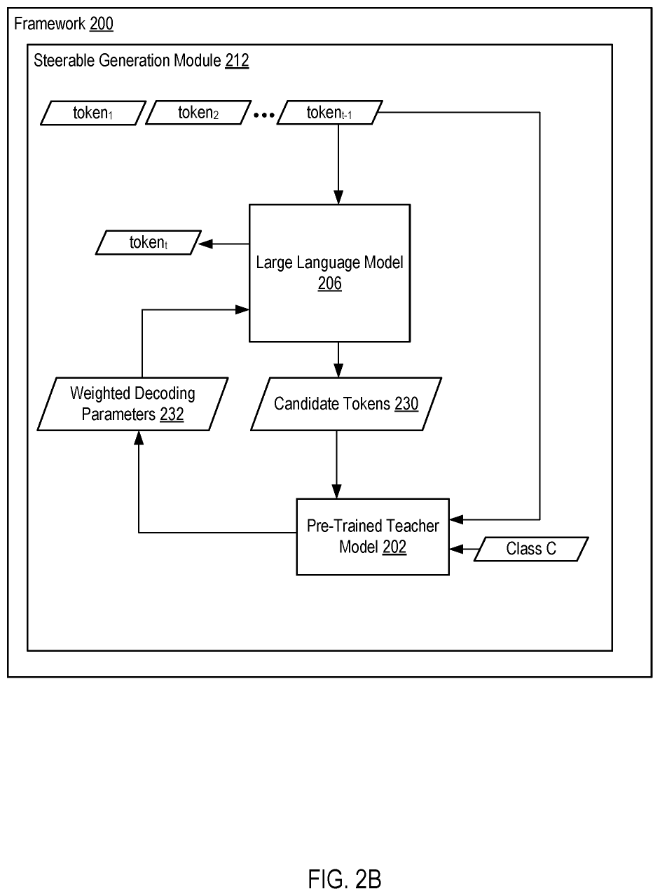

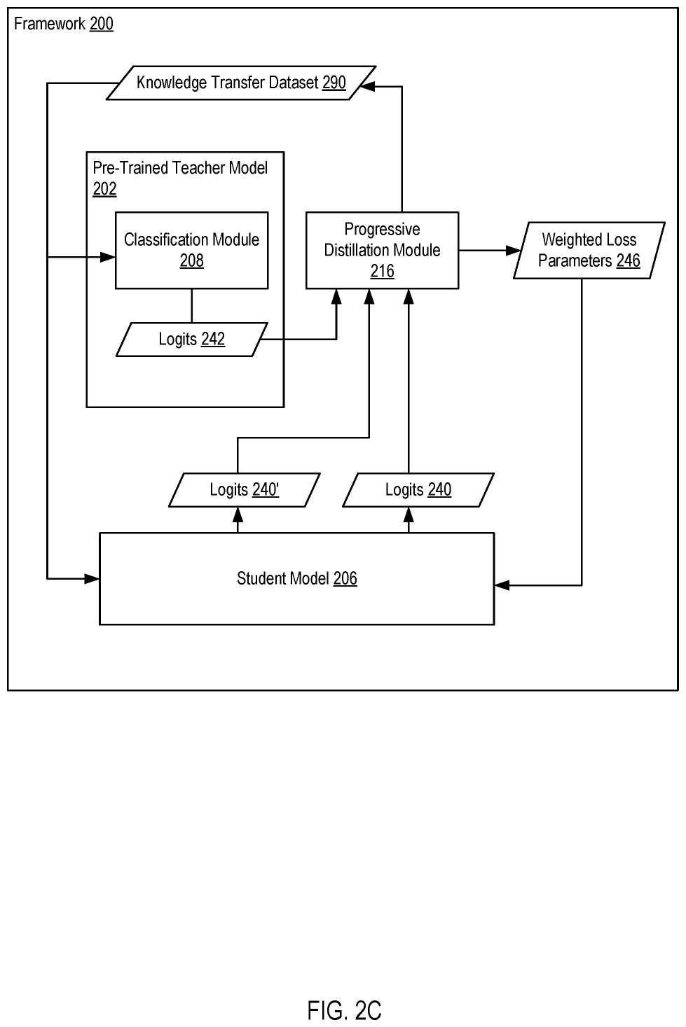

FIGS. 2A-2C set forth block diagrams of an example framework 200 for data-free knowledge distillation for text classification in accordance with at least one embodiment of the present disclosure. The framework 200 includes a pre-trained teacher model 202 based on an artificial neural network that has been trained to perform a natural language processing task such as text classification. The teacher model 202 includes an input layer, an output layer, and one or more hidden or deep layers. In some examples, the teacher model 202 employs a transformer-based architecture, although it will be appreciated that other architectures may be used such as convolutional neural networks (CNN), recurrent neural networks (RNN), and other machine learning architectures suitable for natural language processing, text classification, and/or text generation. In some examples, the pre-trained teacher model 202 has been trained on a dataset 250, also referred to herein as the original training dataset 250.

In a particular example, the teacher model 202 is pre-trained to perform text classification. Text classification includes fitting a sequence of unstructured text to one or more predefined classifications, also referred to as class dimensions. The sequence of text is then associated with a label of the classification. For example, in a binary classification task, a sequence of text could be assigned a label of 1 or 0, representing the categories pertinent to the task. For instance, in a movie review sentiment analysis, these labels might correspond to positive or negative sentiments. In a multi-class classification task, a sequence of text might be labeled with one or more topics related to the text sequence (e.g., sports, politics, business, etc.). A classification module 208 of the teacher model 202 is adapted to receive a text sequence and a class dimension, detect one or more classifications for the text sequence based on its training, and output the label of the classification. As used herein, ‘class,’ ‘classification,’ ‘label,’ and ‘attribute’ may be used interchangeably.

In some examples, the original dataset 250 includes a corpus of unstructured text sequences. Class dimensions are associated with the dataset 250 as well as a classification label for each sequence. A text sequence is input to the model, the text sequence is classified by the model, and the model's classification is compared to the actual classification for the sequence. The one or more weights in the model are adjusted, the text sequence is reinput to the model in subsequent training epochs, and the model's classification is again compared to the actual classification. If the output is more correct, the adjustment to the weight is kept, otherwise the adjustment is discarded. Thus, the actual sequence classifications are used as ground truths for a loss function that is applied to the model. The loss function quantifies how well the model is performing by measuring the difference between the model's predictions and the actual target values. The goal during training is to minimize this loss function, effectively adjusting the model's parameters to make the model's predictions as close as possible to the true values. This process iterates until the model is able to predict the classification with a preconfigured rate of correctness and/or degree of confidence.

In a particular implementation, the teacher model 202 includes a transformer-based text classification neural network that utilizes a transformer architecture characterized by distinct layers with the output of one layer forming the input of the next. In an input embedding layer, a raw text sequence input is tokenized into subword or word tokens and individually embedded into high-dimensional vectors. To incorporate sequence order, positional encoding is added to the input embeddings by a positional encoding layer, thus providing information about token positions. In some examples, multiple transformer encoder layers feature multi-head self-attention mechanisms and feedforward neural networks. These layers capture dependencies between words and complex relationships. After the attention mechanism, a position-wise feedforward network including fully connected layers with rectified linear unit activation functions processes the output. In some examples, before the attention mechanism and after the feedforward network, layer normalization and residual connections are applied to enhance training stability and gradient flow. In some examples, global average pooling may be employed to obtain a fixed-size representation over the text sequence dimension. The output of the transformer encoder layers, or global average pooling layer is applied to multiple dense layers to map features to the desired output one or more of the class dimensions. To produce final predictions, an output layer employs activation functions like SoftMax for multiple classifications or sigmoid for binary classifications, depending on the classification task. In some examples, a loss function is also selected based on the classification task, using binary cross-entropy for binary classification or categorical cross-entropy for multi-class classification.

Given that the teacher model 202 is pre-trained, embodiments in accordance with the present disclosure are directed to training the student model 206 using data-free knowledge distillation in that, for reasons discussed above, the student model 206 is trained without providing the student model access to the original training dataset 250. The student model 206 may also employ a transformer, CNN, or RNN-based architecture. In some examples, the teacher model 202 and the student model 206 implement heterogeneous architectures in that the teacher model 202 employs a different architecture than the student model 206. In some examples, the student model 206 is compressed when compared to the teacher model 202, for example, by including fewer layers. In some examples, the student model 206 is not implemented by copying the layers of the teacher model 202.

To train the student model 206, a steerable generation module 212, using the teacher model 202 and a large language model (LLM) 204, generates a knowledge transfer dataset 290. As discussed above, for the teacher model 202 to train a student model while meeting data-free constraints, the knowledge transfer dataset 290 is synthetically generated. For example, the teacher model 202 is configured to assist in the generation of synthesized data samples (i.e., text sequences) that are related to a particular text classification task. A class label ‘C’ is selected to enable the teacher model 202 to direct or influence the LLM 204 in generating text relevant to class ‘C.’ The resulting synthetic dataset, encompassing all labels, collectively functions as the transfer set (or knowledge transfer task).

The framework 200 also includes the LLM 204 that works with the teacher model 202 to generate synthesized data samples. In some examples, the LLM 204 is an autoregressive unconditional pre-trained language model (e.g., GPT, GPT-2, or others). An autoregressive language model generates text by predicting the next word or token in a sequence based on the preceding context, incrementally building the output by conditioning each prediction on the previously generated elements. The output of an autoregressive language model is a probability distribution over the vocabulary. The word with the highest probability is chosen as the predicted next token. The autoregressive language model can also be configured to output its top-k tokens with the highest probabilities as the top-k predictions for the next word in the sequence. As will be explained in detail below, these top-k tokens can be used by the teacher model 202 to guide the LLM 204 into generated synthetic training data tied to a class/label of interest. Although the LLM 204 is shown in the Figures as a component of the framework 200, it will be appreciated that the LLM 204 may be an independent system and may be, in some examples, remote from the host system of the teacher model 202.

In some examples, to generate synthesized data samples, the steerable generation module 212 leverages the teacher model 202 to guide the LLM 204 into generating text samples that are conditioned on, e.g., relevant to, the particular text classification task. That is, the steerable generation module 212 uses the LLM 204 to generate synthesized data samples that pertain to a particular classification. These synthesized data samples meet the constraint of being ‘data-free’ in that they are data samples that correspond to a particular classification but are not data samples that have been taken from the original training dataset 250 of the teacher model 202 or any other training dataset.

In some implementations, the steerable generation module 212 uses the output of the LLM 204 to generate class-conditional text samples that relate to the text classification task. Weighted decoding is applied by the steerable generation module 212 to the LLM output to influence the LLM output toward a particular classification. For example, to generate synthesized data samples, the LLM 204 generates probabilities for a next token based on a sequence of tokens from previous timesteps. The steerable generation module 212 guides the LLM 204 in selecting a next token that has a high probability of producing an LLM output that falls within a particular classification. For example, given a token vector ‘The film was . . . ’ the LLM 204 generates a probability distribution for a potential next token from the model's vocabulary. In one example, the top k next tokens identified by the LLM 204 are selected as a candidate set and each token in the set is concatenated with the token vectors (e.g., ‘The film was great’, the ‘The film was long’, etc.). The steerable generation module 212 determines, for each candidate token, the probability that the concatenated text containing the candidate token from the current timestep will be classified with the particular classification related to the text classification task. The teacher model 202 derives this probability from its own training based on the original training dataset 250. This process is iterative through multiple timesteps. The text string resulting from this iterative process is a synthesized data sample that corresponds to the particular classification label C and is added to a synthesized dataset 260. As the process iterates, synthesized data samples 262 including syntactically-correct class-conditioned text are created. These synthesized data samples 262, or data-free pseudo-data, are added to the synthesized dataset 260.

FIG. 2B illustrates synthesized data sample generation by the steerable generation module 212 for a current timestep ‘t’ and for a particular classification ‘c’. A token vector (token₁, token₂ . . . tokenₜ₋₁) is supplied to the LLM 204 and the steerable generation module 212. The LLM 204 applies a probability function P(xₜ|x_{t:t-1}) across the model vocabulary to generate a set of candidate tokens 230 (e.g., the top k probable tokens for the token vector at the current timestep t). At each timestep t, every candidate token 230 is combined with the tokens generated earlier and inputted into the teacher model 202. The teacher model 202 then calculates the probability P(c|x_{1:t}) representing the likelihood of the text belonging to classification c. The impact of the teacher model 202 is regulated by adjusting a control strength hyperparameter γ. Weighted decoding entails merging the probabilities (i.e., a weighted decoding parameter 232) from the hyperparameter-controlled teacher model with those from the Large Language Model (LLM) for candidate tokens corresponding to the classification c. Accordingly, P(x_{1:T}|c)=Πₜ₌₁^{T}P(xₜ|x_{1:t-1}, c) therefore P(xₜ|x_{1:t-1}, c) is proportional to P(xₜ|x_{1:t-1}, c) P(c|x_{1:t-1})^{γ}. Accordingly, the steerable generation module 212 provides a weighted decoding mechanism that steers the LLM 204 towards generating a text sequence related to a specific classification of interest, where, in some examples, a weighted decoding parameter 232 is a hyperparameter-controlled probability generated by the teacher model for the classification c that is combined with the probability computed by the LLM for a set of a candidate tokens.

Returning to FIG. 2A, the synthesized dataset 260 is supplied to the data augmentation module 214 to create diversified data samples. Adding diversified samples to the knowledge transfer dataset assists in training the student model to recognize different variations of a data sample that correspond to the same classification. A transformation is applied to the synthesized data samples 262 to produce additional diversified data samples 272 with slight perturbations in syntax or semantics while retaining the same meaning and thus the same classification. This improves the generalization and regularization of the knowledge transfer dataset. For example, the text ‘The movie was awesome’ is a diversified data sample of the original text ‘The movie was great’ based on semantic diversification. The text ‘It was a great movie’ is a data sample based on syntactic diversification. In some examples, the data augmentation module 214 generates multiple different diverse data samples for each synthesized data sample to improve the knowledge transfer dataset. The diversified data samples 272 are added to a diversified dataset 270 that is included in the knowledge transfer dataset 290.

In some implementations, the data augmentation module 214 uses back translation to generate diversified data samples 272 from the synthesized data samples 262. A transformation of a synthesized data sample is achieved by translating the sample text to a different language and then back to its original language. For example, sample text that is in English can be translated to Spanish and then back to English. The resulting text sample may include variances in syntax and idiom compared to the original text without diverging from the meaning of the original text. As such, the classification of the synthesized data sample and the diversified data sample remains the same.

In some implementations, the data augmentation module 214 uses a virtual adversarial strategy to generate diversified data samples that include small perturbations to the synthesized data samples. Perturbations can be introduced in the adversarial strategy by making small modifications to many real-values. Since text is discrete, the adversarial perturbation is applied in the embedding space, rather than directly to the discrete text inputs. The magnitude (epsilon) of the perturbations can be selected, and different diversified data samples can be created using different epsilon values for additional diversification.

It will be appreciated that the data augmentation module 214 can employ back translation or adversarial perturbation, or a combination of back translation and adversarial perturbation, to generate diversified data samples 272. For example, adversarial perturbation may be applied after back translation of a synthesized data sample 262.

The synthesized dataset 260 and the diversified dataset 270 compose the knowledge transfer dataset 290 that is used to train the student model 206, as will be discussed in more detail below. It will be appreciated that a data-free class-conditional knowledge transfer dataset 290 is generated without using prompt-based knowledge distillation. This simplifies the generation of the knowledge transfer dataset and improves the quality of the data samples that are generated.

With reference to FIG. 2C, the progressive distillation module 216 trains the student model 206 by applying the knowledge transfer dataset 290 iteratively to the student model 206 and to the classification module 208 of the teacher model 202 in successive epochs. That is, in one epoch, each data sample in the knowledge transfer dataset 290 is input to both the student model 206 and the teacher model 202 for classification. The output logits 240 of the student model 206 and the output logits 242 of the teacher model 202 are compared by the progressive distillation module 216 to determine a loss for that epoch. The progressive distillation module 216 computes a loss function such as Kullback-Leibler (KL) divergence to calculate the difference between the teacher model's classifications and the student model's classifications in the training data. The progressive distillation module 216 supplies weighted loss parameters 246 to the student model 206, which updates its parameters (e.g., biases and weights) through back propagation to minimize the loss.

In some implementations, to determine the loss, the output logits 240 of the teacher model 202 and the output logits 242 of the student model 206 are interpolated to determine the KL divergence. In non-binary classification scenarios, where there are more than two classes, the term ‘logit’ refers to the vector of raw, unnormalized prediction scores for each class dimension before applying a SoftMax activation function that is used to convert these raw scores into class probabilities that sum to 1. The KL divergence is used as a loss function to update the student model 206. In some examples, the output logits 242 of the teacher model 202 are interpolated with the output logits 240′ of the student model 206 from prior epochs.

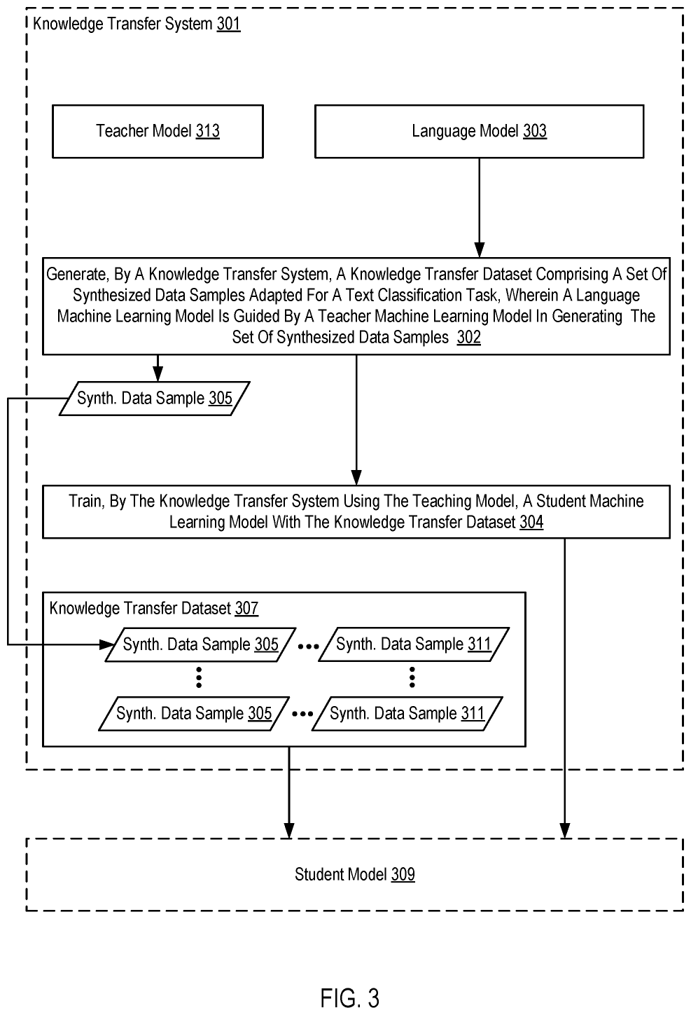

For further explanation, FIG. 3 sets forth a flow chart of an example method for data-free knowledge distillation for text classification in accordance with at least one embodiment of the present disclosure. The method includes generating 302, by a knowledge transfer system 301 using a language machine learning model 303 (a ‘language model’) and a teacher machine learning model 313 (a ‘student model’), a knowledge transfer dataset 307 comprising a set of synthesized data samples 305 adapted for a text classification task. The language model is guided by the teacher model in generating the set of synthesized data samples 305. The teacher model 313 is a pre-trained artificial neural network that has been trained for text classification based on a training dataset. In some examples, the teacher model 313 is an implementation of the pre-trained teacher model 202 described above with reference to FIGS. 2A-2C. In some examples, the text classification task is the classification of text according to a particular class in a set of classes found in the training dataset (e.g., the class dimensions of the training dataset). Thus, the aim of generating 302 the set synthesized data samples 305 is to generate synthesized data samples that fall within a particular classification and that would be classified with that particular classification with a high probability (e.g., with a probability higher than a pre-determined threshold value) when applied as input to the teacher model 313. In some implementations, generating 302 the set synthesized data samples 305 is repeated for different text classification tasks in accordance with different classifications found in an original training dataset. For example, synthesized data samples are generated for all of the classes in the class dimensions of the original training dataset.

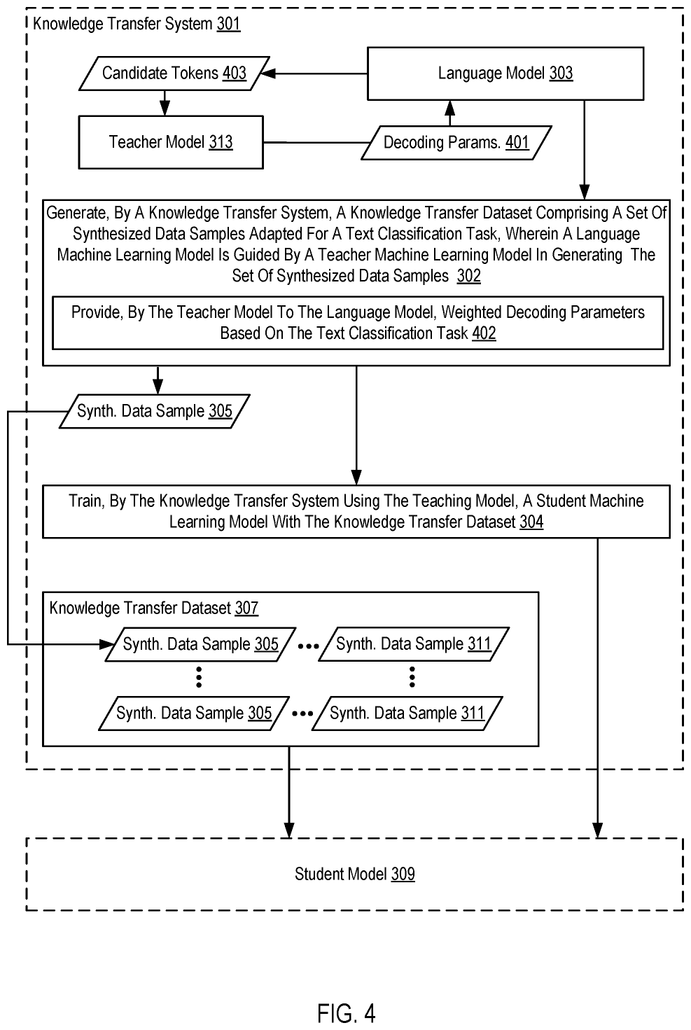

In some implementations, the steerable generation module 212 of the knowledge transfer system 301 generates 302 the set of synthesized data samples 305 adapted for a text classification task by the teacher model 313 guiding the language model 303 into generating text samples that correspond to a particular class, (e.g., a particular class C). The language model 303 may be an autoregressive unconditional pre-trained language model such as the LLM 204 discussed above with reference to FIGS. 2A-2C. The language model 303 generates text by selecting a token based on a vector of previous tokens and a probability distribution of potential next tokens. Based on the probability distribution, the large language model identifies a set of candidate tokens from which to select the next token. For example, the set of candidate tokens may be the top k tokens (e.g., the k number of tokens with the highest probabilities). However, it will be appreciated that in some embodiments the set of candidate tokens is selected using a different methodology, such as a set of tokens with a probability above a particular threshold (top p). This set of candidate tokens is supplied to the teacher model 313. The teacher model 313 influences, based on the particular class C for which data samples are to be generated, which candidate token will be selected by the language model 303 as the next token for the text sample. In some implementations, the teacher model 313 influences the language model 303 by supplying weighted decoding parameters, as was discussed in more detail above and is further explained below with respect to FIG. 4; however, in other implementations a different mechanism can be used to influence the language model 303, such as the teacher model 313 explicitly selecting the next token from the set of candidate tokens based on the particular class C. In addition to generating the set of synthesized data samples 305 for a first text classification task, the steerable generation module 212 of the knowledge transfer system 301 may generate other sets of synthesized data samples 311 for other classes C′ and add those synthesized data samples to the knowledge transfer dataset 307.

In this way, the knowledge transfer system 301 autonomously generates class-conditional data samples while meeting data-free constraints, in that the set of synthesized data samples 305 does not include any data samples taken from the original training dataset or any other dataset of real-world text samples that were not synthesized in the steps described herein. Thus, while these synthesized data samples are particularly adapted as training data for a particular class, the synthesized data samples overcome the challenges with data accessibility arising from confidentiality, privacy, and security policies.

The method of FIG. 3 also includes training 304, by the knowledge transfer system 301 using the teacher model 313, a student machine learning model 309 (a ‘student model’) using the knowledge transfer dataset 307. In some examples, the student model is an artificial neural network such as the student model 206 discussed above with reference to FIGS. 2A-2C. In some implementations, the teacher model 313 and the student model 309 share the same neural network architecture (e.g., the transformer architecture), while in other implementations the teacher model 313 and the student model 309 are heterogeneous in architecture (e.g., a transformer teacher model and an RNN student model). In some examples, the student model 309 is compressed relative to the teacher model 313, such as by including fewer layers than the teacher model 313.

After multiple iterations through different text classification tasks, the knowledge transfer dataset 307 includes synthesized data samples 305, 311 corresponding to different classifications in the set of target classifications (e.g., the class dimensions of the original training dataset). This knowledge transfer dataset 307 is used to train the student model 309. The data transfer system 301 does not have access to the original training dataset that was used to train the teacher model 313; rather, the student model 309 is trained on synthesized data samples in the knowledge transfer dataset 307 and potentially other knowledge transfer datasets that comprise synthesized data samples.

In some implementations, to train the student model 206, the progressive distillation module iteratively applies the knowledge transfer dataset 307 to the student model 309 and to the teacher model 313 in successive epochs. That is, in one epoch, each data sample in the knowledge transfer dataset 307 is input to both the student model 206 and the teacher model 202 for classification. In response, the student model 309 makes a prediction as to the classification of the sample text. The progressive distillation module compares the outputs of the student model 206 and the teacher model 202 to determine a loss for that epoch. A loss function such as KL divergence is used to calculate the difference between the teacher model's classifications and the student model's classifications in the training data. The model parameters of the student model are then updated to minimize the loss and the process is repeated for the next epoch in which each data sample in the knowledge transfer dataset 307 is input to both the student model 206 and the teacher model 202 for classification. In some examples, the student model 206 is considered to be trained once a convergence condition is satisfied, such as correctly predicting classifications within a threshold error rate against a validation dataset and/or predicting classifications with a threshold degree of confidence.

For further explanation, FIG. 4 sets forth a flow chart of another example method for data-free knowledge distillation for text classification in accordance with at least one embodiment of the present disclosure. The method of FIG. 4 extends the method of FIG. 3 in that generating 302, by a knowledge transfer system 301 using a language model 303, the knowledge transfer dataset comprising a set of synthesized data samples 305 adapted for a text classification task. This extension includes providing 402, by the teacher model 313 to the language model 303, weighted decoding parameters 401 based on the text classification task. As discussed above, in predicting a next token in a token vector for a current timestep, the language model 303 generates a set of candidate tokens 403 based on the tokens from the previous timesteps and associates each token with a probability (or alternatively a rank) in a probability distribution. In some implementations, the set of candidate tokens 403 is provided to the teacher model 313 (e.g., to the steerable generation module 212 discussed above). The token vector generated in the previous timesteps is also provided to the teacher model 313. In these implementations, the teacher model 313 concatenates each candidate token with the token vector and determines a class-conditional probability that resulting concatenated text would be classified with the particular class C of the text classification task. The probability is governed by the control strength hyperparameter γ. This adjusted probability (i.e., a weighted decoding parameter), influenced by γ, is combined with the probability scores from the pre-trained large language model, resulting in a weighted probability score. From this score, text is generated relevant to a class C. The γ value signifies the strength or influence of the teacher model on the large language model. Increasing γ enhances the adherence of the generated text to class C. However, excessively high scores may lead to non-fluent text because of the disproportionate weight placed on the teacher model over the language model, which ensures text fluency. Thus, some embodiments cap a maximum probability for the selected text as a value that is less than 100%.

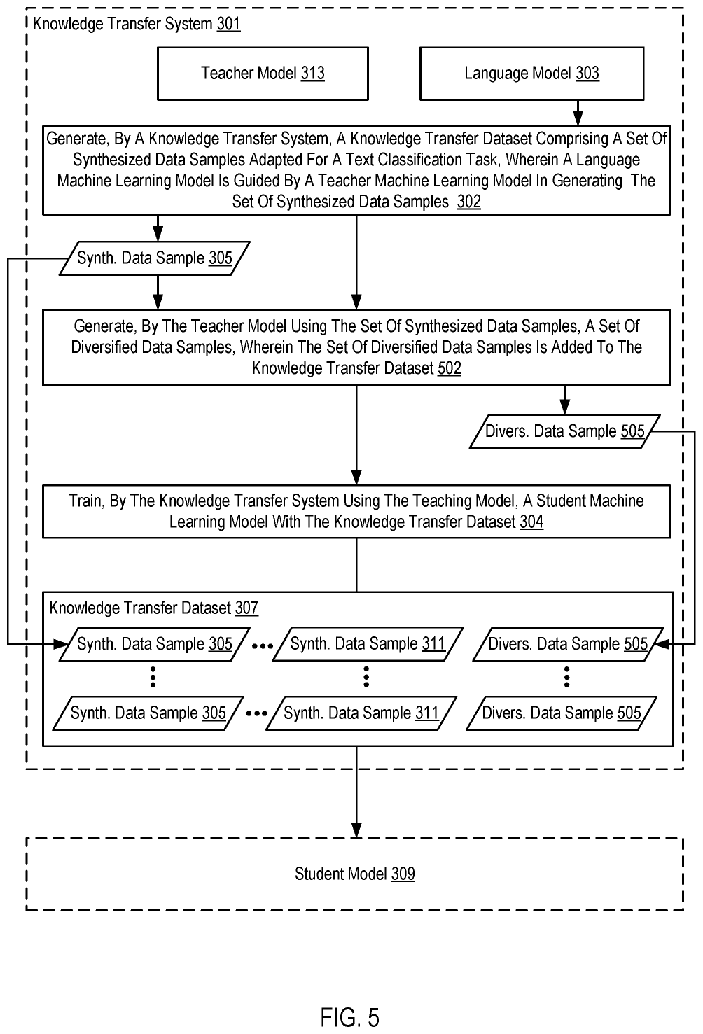

For further explanation, FIG. 5 sets forth a flow chart of another example method for data-free knowledge distillation for text classification in accordance with at least one embodiment of the present disclosure. The method of FIG. 5 extends the method of FIG. 3 in that the method of FIG. 5 further includes generating 502, by the knowledge transfer system 301 using the set of synthesized data samples 305, a set of diversified data samples 505. The set of diversified data samples 505 is added to the knowledge transfer dataset 307. To increase generalization and regularization of the knowledge transfer dataset, the knowledge transfer system 301 (e.g., the data augmentation module 214 described above) generates 502 diversified data samples 505 from synthesized data samples by generating an augmented version of the synthesized data sample. A transformation is applied to the synthesized data samples 305 to produce additional diversified data samples 505 with slight perturbations in the embedding/representational space while retaining the same meaning and thus the same classification. In some examples, the knowledge transfer system 301 generates multiple different diversified data samples for each synthesized data sample to improve the knowledge transfer dataset 307. The diversified data samples 505 are added to the knowledge transfer dataset 307, such that both the synthesized data samples 305 and the diversified data samples 505 derived from the synthesized data samples 305 are used as training data to train the student model 309.

In some implementations, diversified data samples 505 are generated from the synthesized data samples 305 using back translation. A transformation of a synthesized data sample is achieved by translating the sample text to a different language and then back to its original language. For example, sample text that is in English can be translated to Spanish and then back to English. The resulting text sample may include variances in syntax and idiom compared to the original text without diverging from the meaning of the original text. As such, the classification of the synthesized data sample and the diversified data sample remain the same. This back translation is performed in an automated manner via knowledge transfer code 107 of the computer 101. For example, the synthetic sample is input in an automated manner into a first language machine learning model capable of language translation to cause that model to output the translation in the second language. Then the translation is input in an automated manner into another language machine learning model or back into the first language machine learning model capable of language translation to cause that model to output the retranslation back into the original language.

In some implementations, the diversified data samples 505 are generated from the synthesized data samples 305 using virtual adversarial strategy. Adversarial perturbations are applied at the embedding level using the virtual adversarial training strategy to create the diversified data samples. It will be appreciated that the perturbation should not be so substantial so as to change the data sample to a different classification. The intent is to train the student model 309 against misclassifying text based on such divergences. The magnitude (epsilon) of the perturbations can be selected, and different diversified data samples can be created using different epsilon values for additional diversification.

It will be appreciated that the knowledge transfer system 301 can employ back translation or adversarial perturbation, or a combination of back translation and adversarial perturbation, to generate diversified data samples 505. For example, adversarial perturbation may be applied after back translation of a synthesized data sample 305.

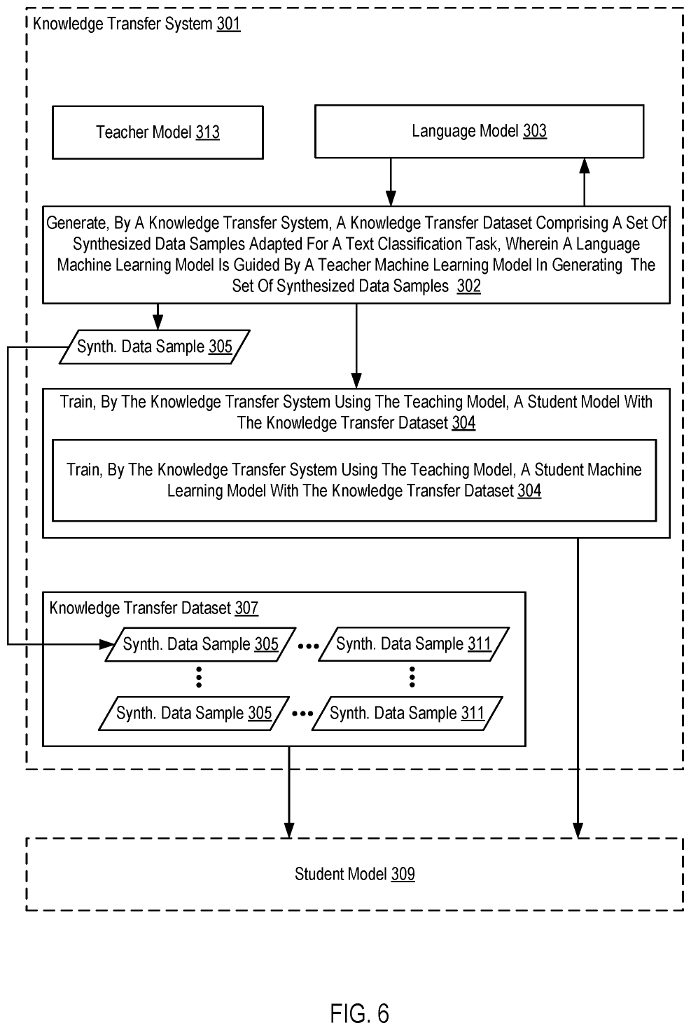

For further explanation, FIG. 6 sets forth a flow chart of another example method for data-free knowledge distillation for text classification in accordance with at least one embodiment of the present disclosure. The method of FIG. 6 extends the method of FIG. 3 in that training 304, by the data transfer system 301 using the teacher model 313, the student model 309 with the knowledge transfer dataset 307 includes updating 602 the student model according to a weighted loss function based on logits output by the teacher model and logits output by the student model. In some examples, to determine the loss, the output logits of the knowledge transfer system 301 and the output logits of the student model 309 from prior training epochs are interpolated to determine the KL divergence. The progressive distillation module uses the KL divergence of the teacher logits and the student logits as a loss function to update the student model 206. In some examples, the output logits of the knowledge transfer system 301 are interpolated with the output logits of the student model 309 from prior epochs.

In view of the foregoing, it can be seen that a data-free knowledge transfer system in accordance with the present improves data-free knowledge transfer between two artificial intelligence models by utilizing a flexible inference-time controllable generation module that steers an unconditional language model towards a desirable class attribute. Compared to a prompt-based reinforcement learning method, the data-free knowledge transfer system in accordance with the present disclosure offers a simpler yet effective solution to produce domain-relevant class-conditional text using a weighted decoding mechanism. Another advantage of this framework is its ability to enhance the transfer and generalization capability of the student model through its progressive distillation strategy. This strategy overcomes the potential pitfalls of other approaches such as unnatural text, undesirable oscillations, instability or getting stuck in local minima by diversifying the generated data samples and applying an iterative training process which in turn provides regularization. Further, the data-free knowledge transfer system in accordance with the present disclosure is adapted for both homogeneous and heterogeneous scenarios, whereas other approaches function only in homogeneous settings.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating, by a knowledge transfer system, a knowledge transfer dataset comprising a set of synthesized data samples adapted for a text classification task, wherein a language machine learning model is guided by a teacher machine learning model in generating the set of synthesized data samples; and
training, by the knowledge transfer system using the teacher model, a student machine learning model by using the knowledge transfer dataset.

2. The method of claim 1, wherein the teacher model was pre-trained for text classification using an original training dataset.

3. The method of claim 2, wherein the original training dataset for the teacher model is inaccessible by the knowledge transfer system.

4. The method of claim 1, wherein the teacher model and student model are implemented by different artificial neural network architectures.

5. The method of claim 1, wherein the student model is differentiated from the teacher model by having at least one of fewer layers and fewer parameters than the teacher model.

6. The method of claim 1, wherein the generating the set of synthesized data samples adapted for the text classification task includes:
providing, by the teacher model to the language model, weighted decoding parameters based on the text classification task.

7. The method of claim 1 further comprising:
generating, by the knowledge transfer system using the set of synthesized data samples, a set of diversified data samples, wherein the set of diversified data samples is added to the knowledge transfer dataset.

8. The method of claim 7, wherein the set of diversified data samples are generated by performing a back-translation of the set of synthesized data samples.

9. The method of claim 7, wherein the set of diversified data samples are generated by augmenting the set of synthesized data samples using an adversarial strategy.

10. The method of claim 1, wherein the training the student model using the knowledge transfer dataset includes:
updating the student model according to a weighted loss function based on logits output by the teacher model and logits output by the student model.

11. A computer system comprising:
a processor set;
a set of one or more computer-readable storage media; and
program instructions, collectively stored in the set of one or more storage media, that, when executed, cause the processor set to perform computer operations comprising:
generating, by a knowledge transfer system, a knowledge transfer dataset comprising a set of synthesized data samples adapted for a text classification task, wherein a language machine learning model is guided by a teacher machine learning model in generating the set of synthesized data samples; and
training, by knowledge transfer system using the teacher model, a student machine learning model by using the knowledge transfer dataset.

12. The computer system of claim 11, wherein the generating the set of synthesized data samples adapted for the text classification task comprises:
providing, by the teacher model to the language model, weighted decoding parameters based on the text classification task.

13. The computer system of claim 11, wherein the computer operations further comprise:
generating, by the knowledge transfer system, a set of diversified data samples, wherein the set of diversified data samples is added to the knowledge transfer dataset.

14. The computer system of claim 13, wherein the set of diversified data samples are generated by at least one of performing a back-translation of the set of synthesized data samples and augmenting the set of synthesized data samples using an adversarial strategy.

15. The computer system of claim 11, wherein the training of the student model using the knowledge transfer dataset comprises:
updating the student model according to a weighted loss function based on logits output by the teacher model and logits output by the student model.

16. A computer program product comprising:
a set of one or more computer readable storage media; and program instructions, collectively stored in the set of one or more storage media, that when executed, cause a processor set to perform computer operations comprising:
generating, by a knowledge transfer system, a knowledge transfer dataset comprising a set of synthesized data samples adapted for a text classification task, wherein a language machine learning model is guided by a teacher machine learning model in generating the set of synthesized data samples; and
training, by the knowledge transfer system using the teacher model, a student machine learning model by using the knowledge transfer dataset.

17. The computer program product of claim 16, wherein the generating the set of synthesized data samples for the text classification task comprises:
providing, by the teacher model to the language model, weighted decoding parameters based on the text classification task.

18. The computer program product of claim 16, wherein the computer operations further comprise:
generating, by the knowledge transfer system, a set of diversified data samples, wherein the set of diversified data samples is added to the knowledge transfer dataset.

19. The computer program product of claim 18, wherein the set of diversified data samples are generated by at least one of performing a back-translation of the set of synthesized data samples and augmenting the set of synthesized data samples by using an adversarial strategy.

20. The computer program product of claim 16, wherein the training the student model using the knowledge transfer dataset comprises:
updating the student model according to a weighted loss function based on logits output by the teacher model and logits output by the student model.
